(19) United States
(12) Patent Application Publication
(10) Pub. No.: US 2018/0145342 A1
(43) Pub. Date: May 24, 2018

(54) FLOW FIELD FOR FUEL CELL INCLUDING GRAPHENE FOAM

(71) Applicants: Seoul National University, R&DB Foundation, Seoul (KR); Institute for Basic Science, Daejeon (KR); Kangwon National University, University-Industry Cooperation Foundation, Chuncheon City (KR)

(72) Inventors: Yung-Eun SUNG, Seoul (KR); Yong-Hun CHO, Gunpo-si (KR); Ji Eun PARK, Seoul (KR); Chi-Yeong AHN, Suncheon-si (KR); Sungjun KIM, Seoul (KR)

(73) Assignees: Seoul National University, R&DB Foundation, Seoul (KR); Institute for Basic Science, Daejeon (KR); Kangwon National University, University-Industry Cooperation Foundation, Chuncheon City (KR)

(21) Appl. No.: 15/814,916

(22) Filed: Nov. 16, 2017

(30) Foreign Application Priority Data
Nov. 24, 2016 (KR) 10-2016-0157712

(51) Int. Cl. H01M 8/0234; H01M 8/04007; H01M 8/2483; H01M 8/1018

(52) U.S. Cl. CPC H01M 8/0234; H01M 8/04074; H01M 2008/1095; H01M 8/1018; H01M 8/2483

(57) ABSTRACT

A flow field including graphene foam for a fuel cell. The flow field is made of graphene foam that enhances mass transport and suffers no corrosion under operating conditions of the fuel cell when compared with conventional flow fields. In addition, compressed graphene foam has smaller in-plane pores due to the compression and has more tortuous pathways for flowing reactants, thereby increasing retention time of reactants and accelerating diffusion of reactants into a gas diffusion layer (GDL). Further, large through-plane pores inside the graphene foam transport reactants to entire areas of a catalyst layer, and faster flow velocity compared with the conventional membrane electrode assembly (MEA) is derived from a decreased flow field width due to compression. Therefore, mass transport of reactants and products is enhanced, and performance of the fuel cell is improved at high current density regions.

### CROSS REFERENCE TO RELATED APPLICATION

The present application claims priority to Korean Patent Application No. 10-2016-0157712, filed Nov. 24, 2016, the entire contents of which is incorporated herein for all purposes by this reference.

### BACKGROUND OF THE INVENTION

### Field of the Invention

The present invention relates generally to a part included in a fuel cell. More particularly, the present invention relates to a part of a fuel cell, which is made of a novel material and is capable of substituting for a conventional flow field of a fuel cell.

### Description of the Related Art

A bipolar plate performs functions as a channel for reactants and products, a current collector, and a mechanical support of membrane electrode assembly (MEA), in a polymer electrolyte membrane fuel cell (PEMFC), and so on. The bipolar plate requires a flow field for distributing reactants, removing generated water, managing generated heat, and collecting electrons.

In particular, in the PEMFC, water-removal capability is important in designing a flow field because water blocks gas transport whereby cell performance is decreased when water floods in the flow field. Therefore, various methods configured to improve the water-removal capability and reactant transport have been proposed in the related art, such as improving a conventional channel/rib distribution structure of a flow field and applying new materials having a novel structure.

Previously, there are known techniques improving the channel/rib distribution such as designing a parallel flow field, a serpentine flow field, and an integrated-type flow field combining the parallel and the serpentine types to improve the water-removal capability and the reactant transport. However, such techniques are still not satisfactory for improving the reactant transport and the water-removal capability.

On the other hand, when applying metal foam as the flow field, the mass transport and the water-removal capability are much improved compared with the flow field of the channel/rib distribution structure so it leads to an improvement in cell performance. However, using the metal foam as a flow field has a problem of corrosion under operating conditions of a fuel cell.

### DOCUMENTS OF RELATED ART

(Patent Document 1) Korean Patent Application Publication No. 10-2012-0049223 (May 16, 2012);

(Patent Document 2) Korean Patent Application Publication No. 10-2015-0096219 (Aug. 24, 2015);

(Patent Document 3) Japan Patent No. 5070548 (Aug. 31, 2012); and

(Patent Document 4) U.S. Pat. No. 8,097,385 (Jan. 17, 2012).

### SUMMARY OF THE INVENTION

Accordingly, the present invention has been made keeping in mind the above problems occurring in the related art, and the present invention is intended to provide a flow field of a fuel cell, which is made of graphene foam that enhances mass transport and suffers no corrosion under operating conditions of a fuel cell when compared with conventional flow fields, thereby realizing excellent performance and durability.

In order to achieve the above objects, there is provided a flow field of a fuel cell, the flow field includes graphene foam.

In addition, the flow field may be a sheet or a film made of the graphene foam.

In addition, the sheet or the film made of the graphene foam may be interposed between a membrane-electrode assembly (MEA) and a bipolar plate when manufacturing the fuel cell.

In addition, the graphene foam may be compressed graphene foam.

In addition, the fuel cell may be a polymer electrolyte membrane fuel cell (PEMFC).

Furthermore, as another aspect of the present invention, there is provided a fuel cell including the flow field.

In addition, the fuel cell includes: a stack laminated with multiple single cells composed by sequentially binding the flow field and the bipolar plate on each side of a membrane-electrode assembly (MEA) composed by sequentially binding electrodes and a gas diffusion layer on each side of an electrolyte membrane containing electrolyte; an inlet line connected to the stack to supply gas to an inside of the stack; an outlet line connected to the stack to discharge gas from the stack; and a heat exchanger connecting the inlet line and the outlet line to heat-exchange inlet gas flowing through the inlet line and outlet gas flowing through the outlet line.

The flow field of the fuel cell according to the present invention is made of the graphene foam that enhances mass transport and suffers no corrosion under operating conditions of a fuel cell when compared with conventional flow fields, thereby realizing excellent performance and durability.

In particular, the compressed graphene foam has smaller in-plane pores due to compression and has more tortuous pathways for flowing reactants, thereby increasing retention time of reactants and accelerating diffusion of reactants into the GDL. In addition, large through-plane pores included in the graphene foam transport reactants to entire areas of a catalyst layer. Furthermore, faster flow velocity compared with the conventional MEA is derived from a decreased flow field width due to compression, thereby facilitating the dragging of water droplets generated from reaction to outside through unused reactant flow. Therefore, mass transport of reactants and products is enhanced, and particularly, performance of the fuel cell is improved at high current density regions.

### BRIEF DESCRIPTION OF THE DRAWINGS

The above and other objects, features and other advantages of the present invention will be more clearly understood from the following detailed description when taken in conjunction with the accompanying drawings, in which:

FIG. 1A shows schematic views of a MEA having a flow field made of graphene foam and a conventional MEA having a serpentine flow field, and FIG. 1B shows photographs of each bipolar plate of the MEA having the flow field made of graphene foam and the MEA having the serpentine flow field;

FIG. 2A is a SEM image showing a top plan view of graphene foam before compression, FIG. 2B is a SEM image showing a cross-sectional view of graphene foam before compression, FIG. 2C is a SEM image showing a plan view of graphene foam after compression, and FIG. 2D is a SEM image showing a cross-sectional view of graphene foam after compression;

FIG. 3A shows polarization curves of a MEA having a flow field made of uncompressed graphene foam and a conventional MEA, and FIG. 3B shows polarization curves of a MEA having a flow field made of compressed graphene foam and the conventional MEA, wherein the MEAs had catalyst loading of 0.2 mg·cm⁻² and a polarization test was performed at 70° C. with fully humidified H2/air;

FIG. 4A shows polarization curves of a MEA having a flow field made of compressed graphene foam and a conventional MEA, and FIG. 4B shows power density difference of the MEA having a flow field made of compressed graphene foam and the conventional MEA, wherein the MEAs had catalyst loading of 0.2 mg·cm⁻² a polarization test was performed at 70° C. H2/air, fully humidified with total outlet pressure of 180 kPa;

FIG. 5 shows oxygen gain graphs of a MEA having a flow field made of compressed graphene foam and a conventional MEA;

FIG. 6A shows Randles equivalent circuit model for electrochemical impedance spectroscopy (EIS), FIG. 6B shows EIS Nyquist plots of a MEA having a flow field made of compressed graphene foam and a conventional MEA at 0.8 V, and FIG. 6C shows EIS Nyquist plots of the MEA having the flow field made of the compressed graphene foam and the conventional MEA at 0.4 V under a fully humidified H₂/air with total outlet of 180 kPa;

FIG. 7A shows a schematic view of reactant flow in a flow field according to a MEA having compressed graphene foam and FIG. 7B shows a schematic view of reactant flow in a flow field according to a conventional MEA;

FIG. 8A shows a photograph of a contact angle of water droplet on a flow field made of compressed graphene foam and FIG. 8B shows a photograph of a contact angle of water droplet on a conventional flow field;

FIG. 9A is a schematic view showing water removal of a MEA having compressed graphene foam and FIG. 9B is a schematic view showing water removal of a conventional MEA.

### DETAILED DESCRIPTION OF THE INVENTION

Exemplary embodiments of the present invention will be described more fully hereinafter with reference to the accompanying drawings. In the following description of the present invention, detailed descriptions of known functions and components incorporated herein will be omitted when it may make the subject matter of the present invention unclear.

Reference will now be made in detail to various embodiments of the present invention, specific examples of which are illustrated in the accompanying drawings and described below, since the embodiments of the present invention can be variously modified in many different forms. While the present invention will be described in conjunction with exemplary embodiments thereof, it is to be understood that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the present invention as defined by the appended claims.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinbelow, the present invention will be described in detail.

A flow field of a fuel cell according to the present invention includes graphene foam (GF).

Graphene foam is a material combining structural characteristics of graphene and metal foam and has a successive three-dimensional connective network structure. In addition, the graphene foam has no junction resistance between graphene layers configured to form the graphene foam and provides an internal connective structure having high conductivity with no defect between the graphene layers. Furthermore, graphene foam has a 99.7% degree of porosity and thereby can be ideally applied as a scaffold having synergy effect by complexation with other materials. Meanwhile, physical properties of the graphene foam are not specifically limited, but as an example, an interlayer space of the graphene layers configured to foam the graphene foam may be greater than 0 and equal to or less than 0.34 nm and the graphene foam may include 100 μm to 300 μm of micropores and the porosity thereof may be equal to or less than 80% and equal to greater than 99.7%.

It is preferable that the flow field for the fuel cell made of the graphene foam may be a sheet or a film made of the graphene foam. Such form may be easily manufactured by interposing the graphene foam sheet or film between a membrane electrode assembly (MEA) and a bipolar plate.

Meanwhile, it is preferable that the graphene foam is compressed graphene foam for the flow field by applying compressive stress. A porosity of the compressed graphene foam decreases slightly compared with uncompressed graphene foam, but the compressed graphene foam still has a desired porosity and a porous structure. In addition, the reduced porosity due to compression forms smaller pores in an in-plane direction so tortuous pathways of serpentine is formed, thereby accelerating diffusion of reactants into a gas diffusion layer (GDL).

In addition, a type of the fuel cell is not specifically limited, but as an example, the fuel cell may be a polymer electrolyte membrane fuel cell (PEMFC).

Furthermore, the present invention provides a fuel cell having the flow field made of the graphene foam. The fuel cell includes generally known fuel cells in the art except for a fuel cell having a flow field made of graphene foam.

As an example of the fuel cell, the present invention provides the fuel cell including: a stack laminated with multiple single cells composed by sequentially binding the flow field and the bipolar plate on each side of a membrane-electrode assembly (MEA) composed by sequentially binding electrodes (anode and cathode) and a gas diffusion layer on each side of an electrolyte membrane containing electrolyte; an inlet line connected to the stack to supply gas to an inside of the stack; an outlet line connected to the stack to discharge gas from the stack; and a heat exchanger connecting the inlet line and the outlet line to heat-exchange inlet gas flowing through the inlet line and outlet gas flowing through the outlet line.

The flow field of the fuel cell according to the present invention is made of the graphene foam that enhances mass transport and suffers no corrosion under operating condition of the fuel cell when compared with the conventional flow fields, thereby realizing excellent performance and durability. In particular, the compressed graphene foam has smaller in-plane pores due to compression so has more tortuous pathways for flowing reactants, thereby accelerating diffusion of reactants into the GDL. Additionally, large through-plane pores included in the graphene foam transport reactants to entire areas of a catalyst layer. Furthermore, faster flow velocity compared with the conventional MEA is derived from a decreased flow field width due to compression, thereby facilitating dragging of water droplets generated from reaction through unused reactant flow to outside. Therefore, mass transport of reactants and products is improved, and particularly, performance of the fuel cell is improved at high current density regions.

Hereinbelow, the present invention will be described in detail with reference to specific examples. However, it should be understood that the examples of the present invention may be changed to a variety of examples and the scope and spirit of the present invention are not limited to the example described hereinbelow. In the following examples disclosed herein are merely representative for purposes of helping more comprehensive understanding of the present invention.

### PREPARATION EXAMPLE

### Manufacture of a MEA Having a Flow Field Made of Graphene Foam

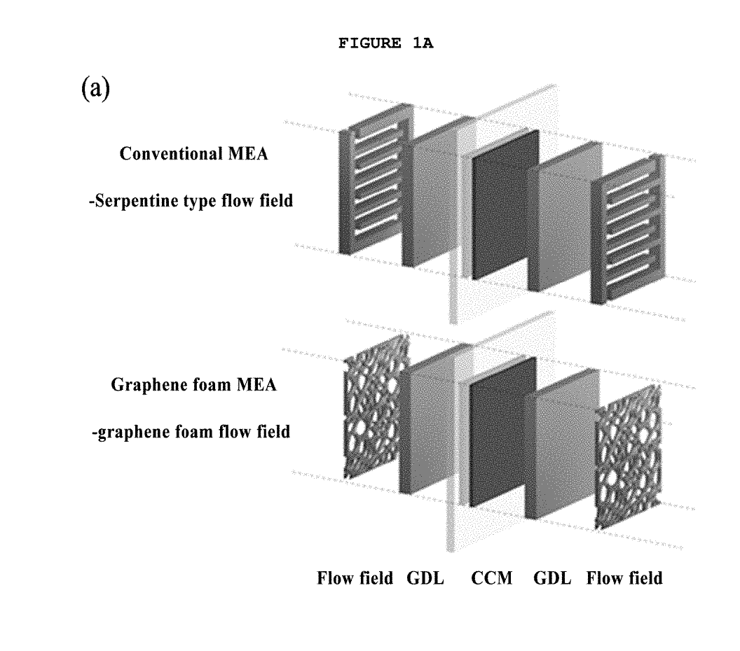

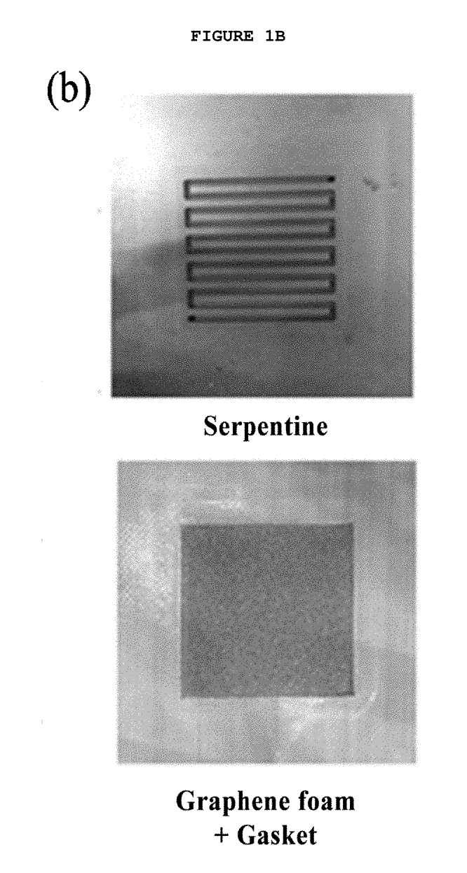

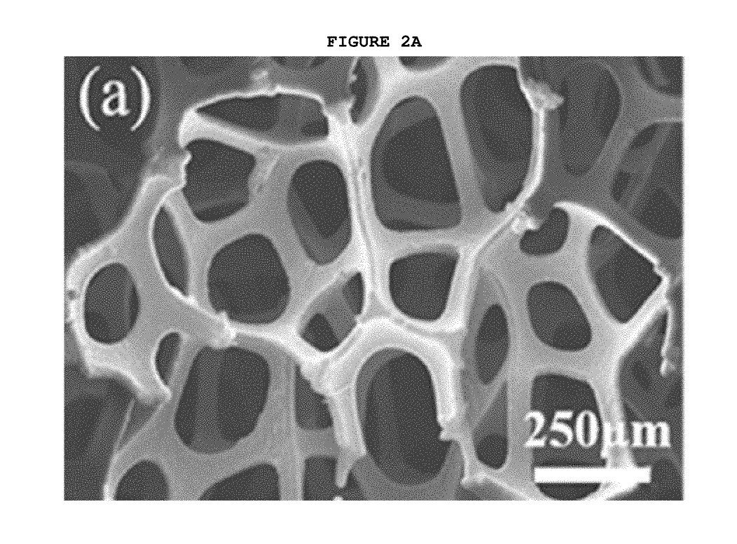

To manufacture a MEA having a flow field made of graphene foam shown in second one of schematic views of FIG. 1A, graphene foam (Graphene Supermarket, Inc.) having average pore diameter of 580 μm and a thickness of 1 mm was disposed on a bipolar plate as a flow field. Next, a gasket was disposed along a periphery of the graphene foam to seal gas and to easily control the thickness of the graphene foam.

The MEA was manufactured by catalyst coated membrane (CCM) method. Here, Nafion™212 was used as a polymer electrolyte membrane, cathode and anode were formed with catalyst loading of 0.2 mg·cm⁻² on the electrolyte membrane by using catalyst ink containing 40 wt % Pt/C, and a gas diffusion layer (GDL, Sigracet 35BC) was formed on each side of the CCM.

The bipolar plate and the MEA manufactured above were bonded together and then the MEA having the flow field made of the graphene foam was obtained. The graphene foam was compressed when assembling the cell to improve electrical conductivity and to accelerate diffusion of reactants into the GDL.

### COMPARATIVE EXAMPLE

### Manufacture of a Conventional MEA Having a Serpentine Flow Field

To manufacture a conventional MEA shown in first one of schematic views of FIG. 1A, MEA was manufactured in a same manner with Preparation Example except engraving a serpentine flow field on a bipolar plate.

### EXPERIMENTAL EXAMPLE

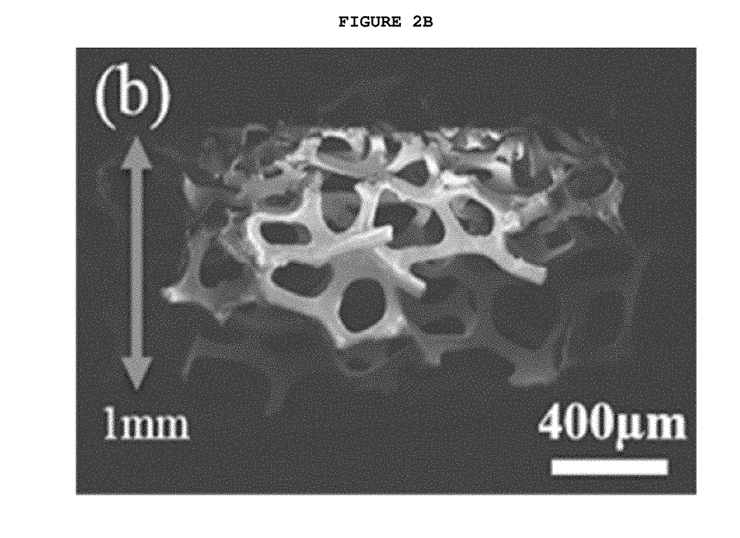

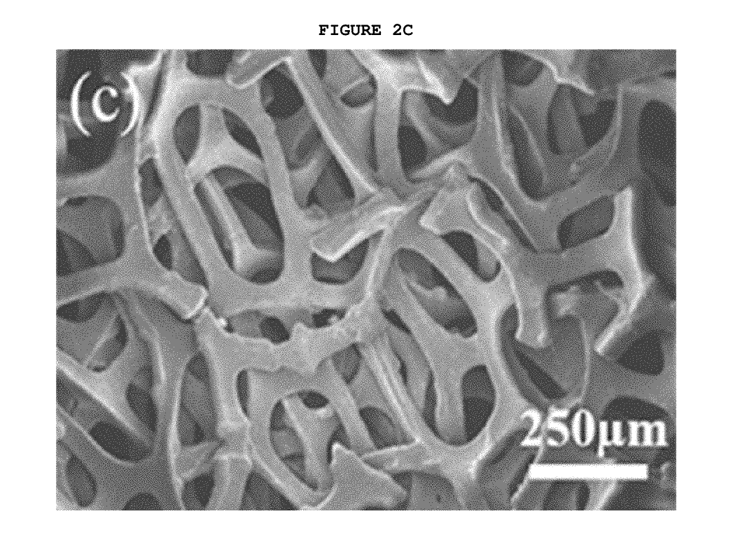

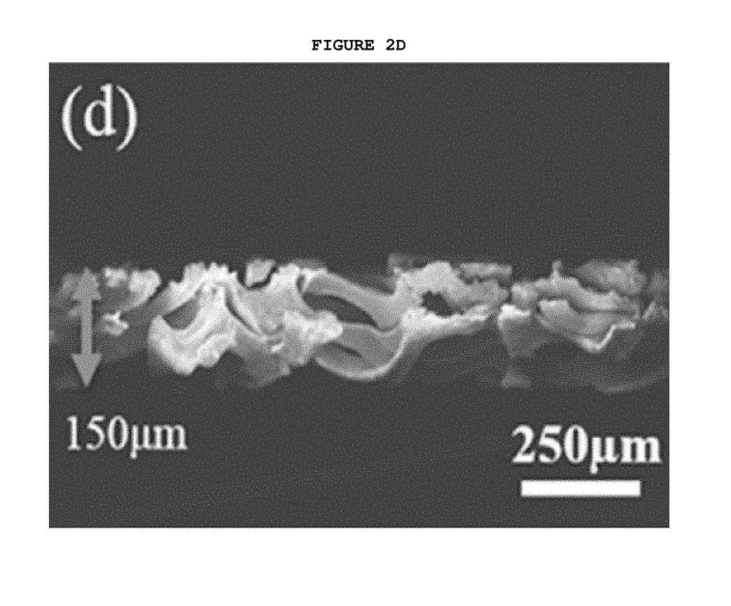

Porosities of the graphene foam before and after compression are shown in Table 1 hereinbelow. FIG. 2A is a SEM image showing a plan view of the graphene foam before compression, FIG. 2B is a SEM image showing a cross-sectional view of the graphene foam before compression, FIG. 2C is a SEM image showing a plan view of the graphene foam after compression, and FIG. 2D is a SEM image showing a cross-sectional view of the graphene foam after compression.

TABLE 1
Porosity of graphene foam (%)

| | Uncompressed foam | Compressed foam |
|---|---|---|
| Porosity (%) | 96.25 | 88.99 |

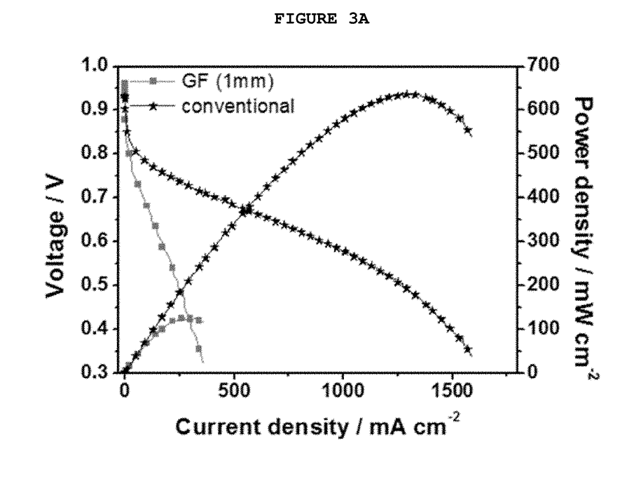

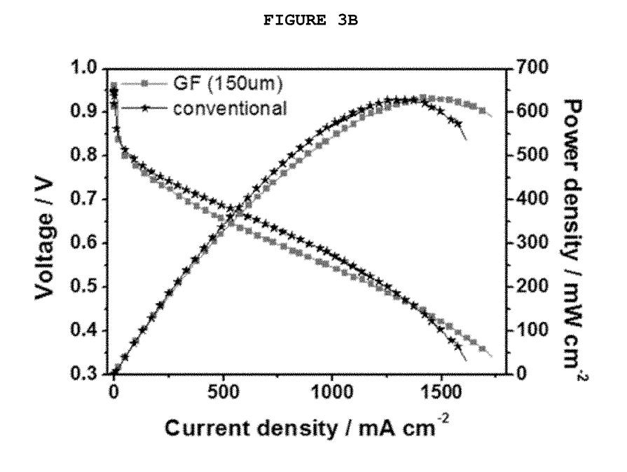

It is measured that the graphene foam before compression had a thickness of 1 mm and a porosity of 96.25% (refer to FIG. 2B). Such high porosity over 90% enabled reactants pass the flow field while the reactants were not distributed uniformly, so performance of the MEA having the flow field made of the graphene foam before compression was much lower compared with the conventional MEA (refer to FIG. 3A).

The graphene foam was compressed to a thickness of 150 μm (refer to FIG. 2D) to improve distribution of reactants, as shown in FIG. 3B, whereby performance of MEA having the flow field made of compressed graphene foam was much improved such that having equivalent to the performance of the conventional MEA. The compressed graphene foam had a slightly decreased porosity but still had a proper porosity and a porous structure. The decreased porosity due to compression formed smaller pores in an in-plane direction and tortuous pathways thereby increasing retention time of reactants.

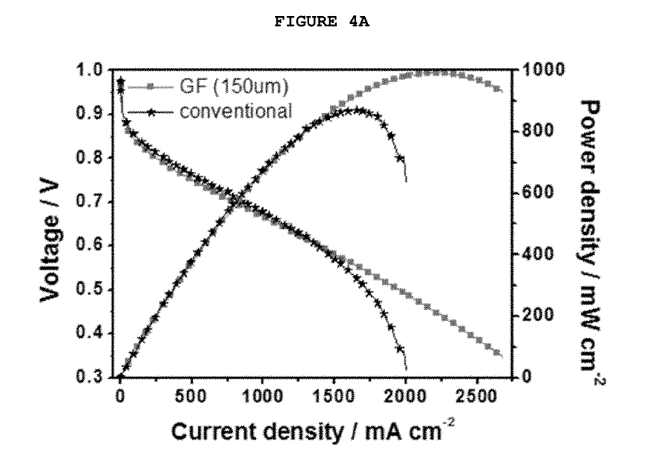

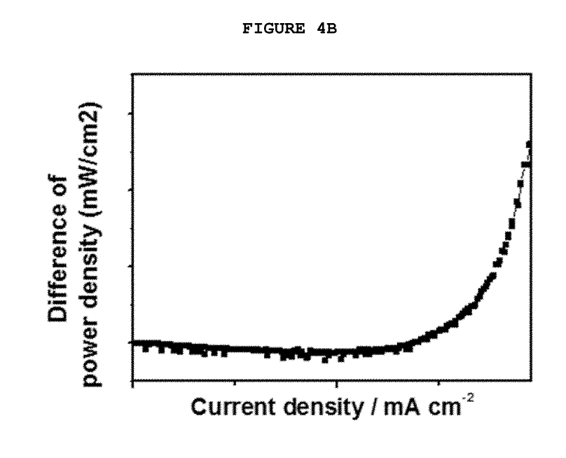

FIG. 4A shows polarization curves of the MEA having a flow field made of the compressed graphene foam and the conventional MEA, and FIG. 4B shows power density difference of the MEA having the flow field made of the compressed graphene foam and the conventional MEA, wherein the MEAs had the catalyst loading of 0.2 mg·cm⁻² and a polarization test was performed at 70° C. H2/air, fully humidified with total outlet pressure of 180 kPa.

In high voltage regions (E>0.6 V), the performance of the MEA having the compressed graphene foam was slightly lowered than the conventional MEA which means that conductivity of the graphene foam was lower than the conventional flow field since a rib area is much smaller than a channel area. According to Kuran et al, it is known that a thinner rib width and a lower channel-rib ratio limit transfer of electrons and reduce conductivity.

However, the MEA having the compressed graphene foam showed higher current density than the conventional MEA thereof in low voltage regions (E<0.6 V). For the conventional MEA, cell voltage was dropped sharply due to water flooding in the cathode when the current density exceeded 1.5 A·cm⁻². On the other hand, the current density of the MEA having the compressed graphene foam was 2.436 A·cm⁻² at 0.4 V, which was approximately 30% greater than conventional MEA as shown in Table 2.

TABLE 2
Comparison in current densities of the MEAs

| | 0.7 V | 0.6 V | 0.4 V |
|---|---|---|---|
| Graphene foam MEA, | 798 (92%) | 1397 (101%) | 2436 (128%) |
| 1.8 bar (mA · cm⁻²) | | | |
| Conventional MEA, | 872 | 1383 | 1900 |
| 1.8 bar (mA · cm⁻²) | | | |

Moreover, the power density difference between two MEAs was remarkable at high current density regions where the high concentration polarization related with mass transport was dominant (refer to FIG. 4B). The result shows that reactants were distributed evenly and generated water was removed without flooding when the graphene foam as a flow field was used, thereby reducing concentration loss effectively.

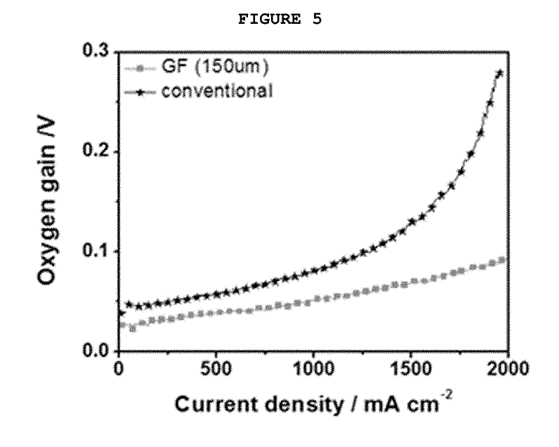

An oxygen gain experiment and an electrochemical impedance spectroscopy (EIS) measurement were conducted to verify an effect of the graphene foam on improved mass transport. The oxygen gain experiment measures difference in cell voltages at a given current density under oxygen-rich condition (O₂) and under oxygen-depleted condition (air). Under the oxygen-rich condition, mass transport resistance is negligible. However, the cathode is not capable of transporting oxygen easily due to reduced oxygen partial pressure and blanketing effect of nitrogen in atmospheric condition. By comparing the difference between cell voltages of under oxygen and under air condition, mass transport resistance of MEA can be measured. In other words, decreased oxygen gain indicates lower mass transport resistance, leading to improved mass transport. FIG. 5, which shows oxygen gain graphs of the MEA having the flow field made of the compressed graphene foam and the conventional MEA, shows that oxygen gain of the MEA having the flow field made of the compressed graphene foam was lower than the conventional MEA in entire current density regions.

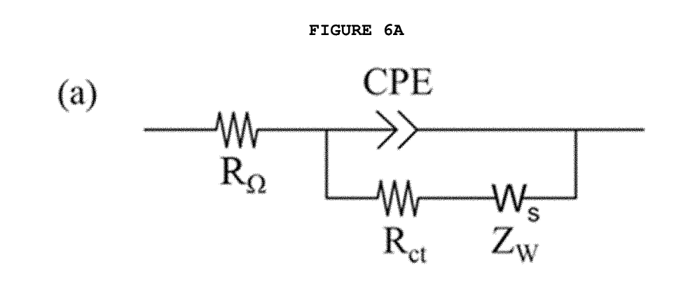

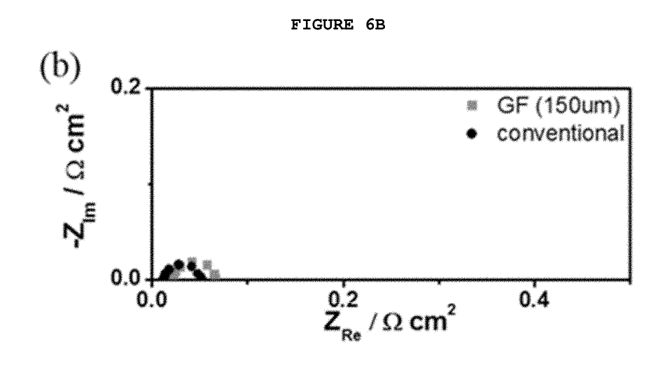

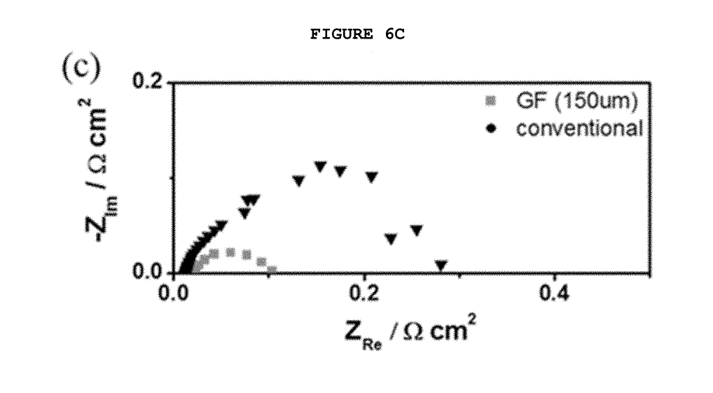

It is generally known that EIS shows certain component resistance contributes to overall impedance. FIG. 6A shows the equivalent circuit of modified Randles model, purposely chosen for the present invention. R_{Ω}, R_{ct}, and Z_{w} are ohmic resistance, charge transfer resistance, and Warburg impedance, respectively. FIGS. 6B and 6C show Nyquist plots obtained at 0.8 V and 0.4 V, respectively. The high-frequency intercept is R_{Ω}, which shows the sum of the ionic and electronic resistances of cell components. The diameter of semicircle at high frequency presents R_{ct}. The Nyquist plot obtained at 0.8 V only had R_{ct} (refer to FIG. 6B). On the other hand, two arcs were shown when measured at 0.4 V such that charge transfer occurs at high frequency and mass transport occurs at low frequency (refer to FIG. 6C). A single semicircle was shown at 0.8 V because activation kinetics were dominant but mass transport effect was negligible at high cell voltage. The ohmic and the charge transfer resistance of the MEA having the compressed graphene foam as the flow field was slightly larger than the conventional MEA because the electrical conductivity of graphene foam was lower than electrical conductivity of graphite bipolar plate due to low channel-rib ratio of the graphene foam. Such result corresponds with the result of the polarization test shown in FIG. 4A. However, as shown in FIG. 6C, the diameter of semicircle of the MEA having the compressed graphene foam as the flow field at 0.4 V was much smaller than the conventional MEA. Such smaller diameter of the semicircle at 0.4 V means that the MEA having the graphene foam as the flow field has lower mass transport resistance. Therefore, the results indicate that applying the graphene foam as a flow field lowers the mass transport resistance significantly instead of having slightly higher ohmic resistance and charge transfer resistance thereby improving cell performance at high current density.

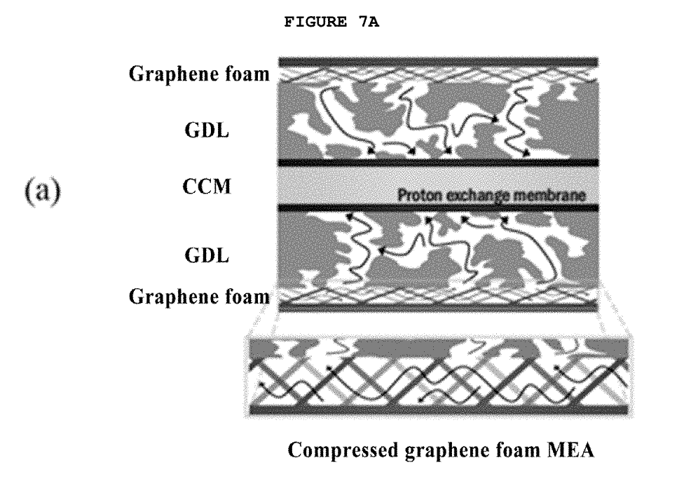

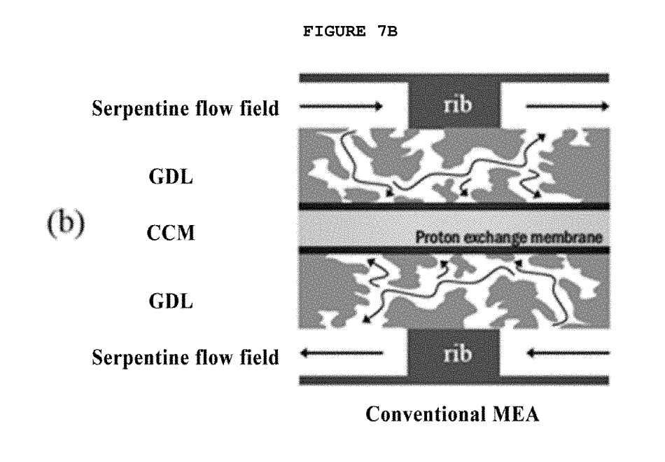

FIG. 7A shows a schematic view of reactant flow in a flow field according to a MEA having compressed graphene foam and FIG. 7B shows a schematic view of reactant flow in a flow field according to a conventional MEA.

Referring to FIGS. 7A and 7B, considering the in-plane direction, reactants merely pass through the flow field in the conventional MEA, however, the compressed graphene foam forms tortuous pathways thereby increasing retention time of reactants and diffusing more reactants into GDL. On the other hand, the compressed graphene foam distributes reactants through the entire areas of the catalyst layer due to high porosity thereof in a through-plane direction.

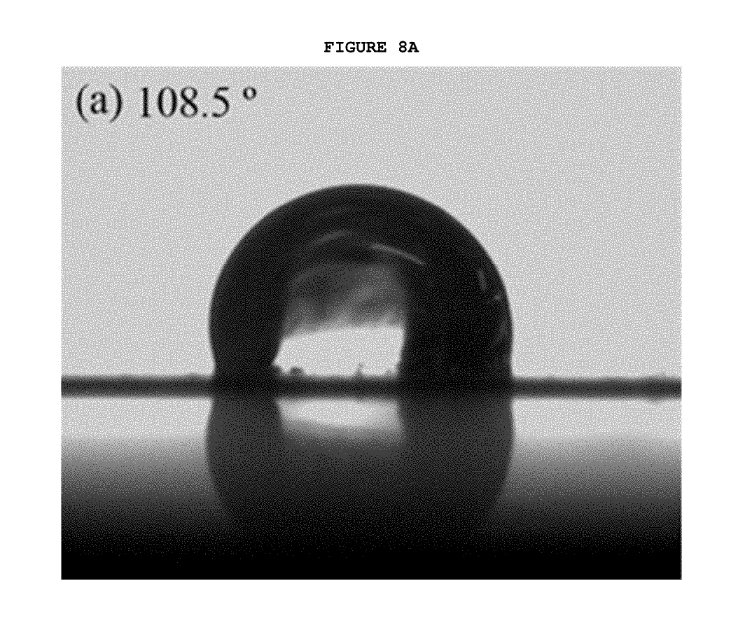

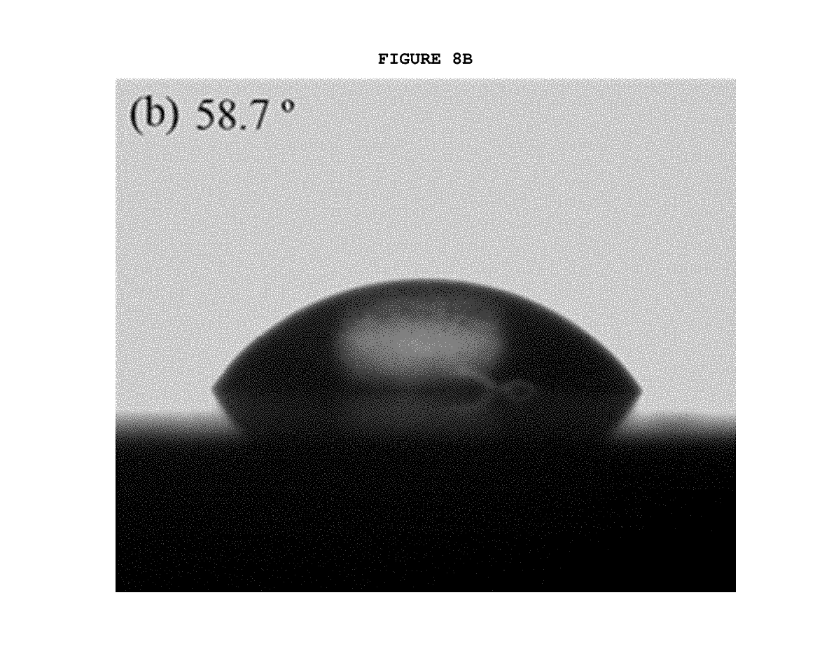

In addition, the compressed graphene foam distributes reactants uniformly as described above, and also has hydrophobicity thereby removing generated water effectively. FIG. 8A shows a photograph of a contact angle of water droplet on the flow field made of the compressed graphene foam and FIG. 8B shows a photograph of a contact angle of water droplet on the conventional flow field, in detail, FIGS. 8A and 8B shows the contact angle of the graphene foam (108.5°) and the contact angle of nickel foam (58.7°), respectively. According to FIGS. 8A and 8B, the graphene foam is much hydrophobic than the nickel foam since the contact angle of the graphene foam was larger than the contact angle of the nickel foam. While Tzseng et al. treated nickel foam with polytetrafluoroethylene (PTFE) to increase hydrophobicity thereof, the graphene foam is originally hydrophobic such that the graphene foam as a flow field is capable of removing generated water effectively without additional treatment with hydrophobic material such as PTFE.

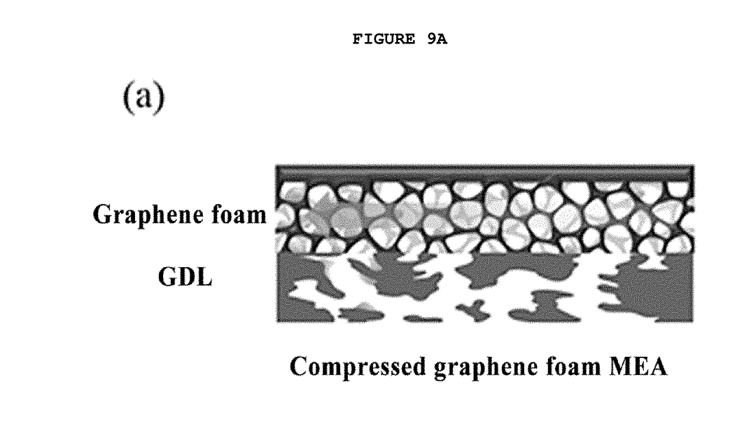

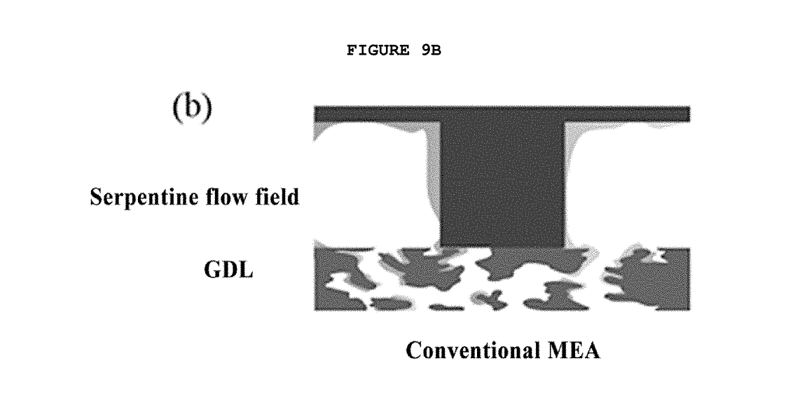

Furthermore, the decreased thickness of the graphene foam due to compression improves water removal. While the thickness of the conventional flow field was 1 mm, the thickness of the graphene foam was decreased from 1 mm to 150 μm due to compression in the present invention so as to increase conductivity of the graphene foam and to accelerate diffusion of reactants into the GDL, thereby faster flow velocity was induced due to decrease in volume of the flow field. It is easy to pull water droplets in a flow field by faster flow velocity. It is possible that generated water forms water droplets due to hydrophobicity of the graphene foam and faster flow velocity due to decreased thickness pulls excess water droplets to outside through reactant flow as shown in FIGS. 9A and 9B.

Consequently, applying the graphene foam as a flow field enables distributing reactants to entire areas uniformly, removing generated water effectively, and preventing water flooding thereby improving cell performance significantly.

1. A flow field of a fuel cell, the flow field comprising graphene foam.

2. The flow field of claim 1, wherein the flow field is a sheet or a film made of the graphene foam.

3. The flow field of claim 2, wherein the sheet or the film made of the graphene foam is interposed between a membrane-electrode assembly (MEA) and a bipolar plate when manufacturing the fuel cell.

4. The flow field of claim 1, wherein the graphene foam is compressed graphene foam.

5. The flow field of claim 1, wherein the fuel cell is a polymer electrolyte membrane fuel cell (PEMFC).

6. A fuel cell comprising the flow field of claim 1.

7. The fuel cell of claim 6, including:
a stack laminated with multiple single cells composed by sequentially binding the flow field and the bipolar plate on each side of a membrane-electrode assembly (MEA) composed by sequentially binding electrodes and a gas diffusion layer on each side of an electrolyte membrane containing electrolyte;
an inlet line connected to the stack to supply gas to an inside of the stack;
an outlet line connected to the stack to discharge gas from the stack; and
a heat exchanger connecting the inlet line and the outlet line to heat-exchange inlet gas flowing through the inlet line and outlet gas flowing through the outlet line.
